(19) United States
(12) Patent Application Publication
(10) Pub. No.: US 2023/0130769 A1
(43) Pub. Date: Apr. 27, 2023

(54) GLUE FOR ROLLING PAPER

(71) Applicants: Isaul Trinidad, Long Beach, CA (US); Cole Pummell, Long Beach, CA (US)

(72) Inventors: Isaul Trinidad, Long Beach, CA (US); Cole Pummell, Long Beach, CA (US)

(21) Appl. No.: 17/973,127

(22) Filed: Oct. 25, 2022

Related U.S. Application Data
(60) Provisional application No. 63/271,415, filed on Oct. 25, 2021.

(51) Int. Cl. C09J 101/26; C09J 9/00

(52) U.S. Cl. CPC C09J 101/26; C09J 9/005; A24D 1/022

(57) ABSTRACT

A glue composition of rolling/wrap papers that has stronger adhesive bonds and can be applied externally without a need for wetting the glue. The glue composition includes Bermocoll 320 and water. The glue composition is prepared by adding Bermocoll 320 in hot water with blending to prevent lump formation. The resulting composition can be cooled down at room temperature.

### CROSS-REFERENCE TO RELATED APPLICATIONS

This application claims priority from a U.S. Provisional Patent Appl. No. 63/271,415 filed on Oct. 25, 2021, which is incorporated herein by reference in its entirety.

### FIELD OF INVENTION

The present invention relates to a glue composition and a method of manufacturing thereof, and more particularly, the present invention relates to glue for rolling paper.

### BACKGROUND

Wraps, also popularly known as rolls, are used to smoke tobacco, hemp, and the like. The warps are made by rolling a specialized paper, also known as rolling paper. The rolling paper has on one of its edges, a pre-applied glue that is used to stick the leading edge of the rolling paper while rolling. A user while rolling can slightly wet the glue, for example by licking. Too much wetting of the glue may make the rolling paper weak and useless. Moreover, the adhesive bonds are generally weak and often come apart during smoking. The glue is also available separately that can be applied to the rolling paper during the rolling process. However, such glue also suffers from the same drawbacks i.e., weak adhesive bonds that may come apart while smoking.

A need is therefore appreciated for a novel glue composition that is devoid of the drawbacks of known glue compositions for rolling papers.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a glue composition for a rolling paper that has a stronger adhesive bond.

It is another object of the present invention that the glue composition can be applied to the rolling paper during making the roll.

It is still another object of the present invention that the glue composition is made from all-natural ingredients.

It is a further object of the present invention that the glue composition does not have any toxic ingredients.

It is yet another object of the present invention that the integrity of the roll does not come apart during smoking.

In one aspect, disclosed is a glue composition for rolling papers, the glue composition consists essentially of about 5% Bermocoll 320 and water. The glue composition further comprises naturally derived preservatives. The glue composition further comprises naturally derived flavoring agents.

In one aspect, disclosed is a glue formulation for adhering rolling paper, the glue composition consists essentially of about 5% Bermocoll 320 and water. The glue formulation is in stick form. The glue formulation is in gel form.

In one aspect, disclosed is a method of preparing a glue composition for rolling paper, the method consists essentially of heating water to about 140° F. in a container; adding, to the hot water, about 3.5 cups of Bermocoll 320, wherein the cup has a volume of about 240 ml; blending the Bermocoll 320 to prevent lump formation to obtain a composition; and cooling the composition at room temperature. The method further comprises adding naturally derived preservatives to the cooled composition. The method further comprises adding naturally derived flavoring agents to the cooled composition. The method further comprises formulating the composition as a stick. The method further comprises formulating the composition as a gel.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation.

Disclosed is a novel glue composition for rolling papers. The disclosed glue composition provides stronger adhesive bonds that prevent the wrap from falling apart during smoking. The wrap adhered using the disclosed glue composition can easily withstand shocks while handling and transportation. The disclosed glue composition can be applied externally to the rolling paper during the rolling process.

The disclosed glue composition can be advantageous in that it is made completely from natural ingredients. The disclosed composition can provide a long-lasting adhesive bond. Moreover, the disclosed glue composition can be applied to the rolling paper while wrapping the paper for smoking. The rolling paper can be used for smoking cannabis, tobacco, and the like.

The disclosed composition can include Bermocoll 320 which is a non-ionic, water-soluble cellulose ether. Bermocoll 320 is commercially available and used in several formulations as a thickener. Preferably the composition can include Bermocoll 320 and water as the main ingredients. The Bermocoll 320 can be of high purity and made for edible purposes. Similarly, the water used can be distilled water for high purity and sterility. The composition may also include Prolong Liquid 2.0 which is a natural ingredient and commercially available. Prolong Liquid 2.0 is a complex polymer that is obtained from plant cell walls. It has a natural flavor and enhances the shelf life of the disclosed composition by reducing the growth of yeast and bacteria. Prolong Liquid 2.0 is widely used in food products. However, the use of the Prolong Liquid 2.0 is an option in the disclosed composition. The disclosed composition may also contain natural flavoring agents. Perhaps, the disclosed glue composition can be manufactured in different flavors. Examples of flavoring agents include extracts, preferably aqueous extracts, such as aqueous extract of orange peel.

In one implementation, the disclosed glue composition can include about 5 percent of Bermocoll 320 and the rest can be water. Optionally about 0.03 percent of Prolong Liquid 2.0 as a preservative can be added. It is understood, however, that any natural preservative can be added in place of Pro Liquid 2.0. In one implementation, 1-2 percent of other natural flavoring agents can also be added.

In one implementation, disclosed is also a method of preparing the disclosed composition. For preparing the disclosed composition, water can be heated to about 140° F. in a container. To the heated water can be added about 3.5 cups of Bermocoll 320, wherein the cup has a volume of about 240 ml. Added Bermocoll 320 can be thoroughly blended in water to prevent lumps. For example, an immersion blender can be used to blend the Bermocoll 320 in water. Once mixed, the composition can be allowed to cool at room temperature. To the cooled composition can be added Prolong liquid 2.0 or other natural preservatives. Any flavoring agent can be added, and the composition can be mixed to uniformly disperse the added ingredients. It is to be noted that the proportion of ingredients in the disclosed glue composition can be critical for the desired adhesive bond strength.

The disclosed glue composition can be prepared in a variety of formulations, such as a stick, gel, and the like. The glue stick can be encased in a plastic tube and can be applied by rubbing against the surface of rolling paper. In one implementation, the glue stick can be in a form of a Brush Pen applicator. The gel form of the disclosed glue composition can be packed in squeeze bottles. A particular advantage of the disclosed glue composition is that it can be externally applied to the rolling paper easily and there is no need for wetting the deposited glue or the rolling paper. It is understood that rolling paper is available in a variety of compositions, and any such rolling paper is within the scope of the present invention. Also, the term “rolling paper” includes “cigarette paper” and “wrap paper”. The terms “rolling” and “wrapping” are interchangeably used herein. Similarly, the terms “roll” and “wrap” are interchangeably used herein in the disclosure.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A glue composition for rolling papers, the glue composition consists essentially of:
about 5% Bermocoll 320 and water.

2. The glue composition according to claim 1, wherein the glue composition further comprises naturally derived preservatives.

3. The glue composition according to claim 1, wherein the glue composition further comprises naturally derived flavoring agents.

4. A glue formulation for adhering rolling paper, the glue formulation consists essentially of:
about 5% Bermocoll 320 and water.

5. The glue formulation according to claim 4, wherein the glue formulation is in stick form.

6. The glue formulation according to claim 4, wherein the glue formulation is in gel form.

7. A method of preparing a glue composition for rolling paper, the method consists essentially of:
heating water to about 140° F. in a container;
adding, to the hot water, about 3.5 cups of Bermocoll 320, wherein each cup has a volume of about 240 ml;
blending the Bermocoll 320 to prevent lump formation to obtain a composition; and
cooling the composition at room temperature.

8. The method according to claim 7, wherein the method further comprises:
adding naturally derived preservatives to the cooled composition.

9. The method according to claim 7, wherein the method further comprises:
adding naturally derived flavoring agents to the cooled composition.

10. The method according to claim 7, wherein the method further comprises:
formulating the composition as a stick.

11. The method according to claim 7, wherein the method further comprises:
formulating the composition as a gel.
